(19) United States
(12) Patent Application Publication
(10) Pub. No.: US 2025/0291588 A1
(43) Pub. Date: Sep. 18, 2025

(54) SYSTEM AND METHOD FOR GENERATIVE AI POWERED MIGRATION OF LEGACY APPLICATIONS

(71) Applicant: Cognizant Technology Solutions India Pvt. Ltd., Chennai (IN)

(72) Inventors: Mohanapriya Muthulingam, Chennai (IN); Chandrasekaran Natarajan, Chennai (IN)

(21) Appl. No.: 19/078,035

(22) Filed: Mar. 12, 2025

(30) Foreign Application Priority Data
Mar. 15, 2024 (IN) 202441019096

(51) Int. Cl. G06F 8/76

(52) U.S. Cl. CPC G06F 8/76

(57) ABSTRACT

A system and a method for Gen AI powered migration of legacy applications is provided. This technology processes an input file comprising application code objects associated with a legacy application code by populating data present in the input file in response to triggering of an event. The application code objects are validated to modify the application code objects present in the input file based on an outcome of validation. The processed input file is integrated with a target application to perform a check of the application code objects present in the processed input file iteratively by using one or more recommended variants associated with the target application. An outcome of check is extracted as a check file and a non-remediated version of the legacy application code for generating prompts. The generated prompts are executed iteratively for remediating the non-remediated version of the legacy application code for migration.

This application claims the benefit of Indian Patent Application number 202441019096, filed Mar. 15, 2024, which is incorporated by reference in its entirety.

### FIELD

Examples of the present invention relate generally to the field of application migration. More particularly, examples of the present invention relate to a system and a method for generative AI powered migration of legacy applications.

### BACKGROUND

Organizations around the world use different applications and tools for carrying out multiple day-to-day operations. For example, a System Application and Product Enterprise Resource Planning (ERP) Central Component (SAP ECC) application may be used for financing, accounting, human resource management, etc. However, with rapid advancements in technology, the legacy applications and tools used by the organizations are often required to be migrated to latest versions in order for the organization to operate in an efficient manner.

Typically, migration of legacy applications to the latest versions is a complex and a cumbersome task. The legacy applications being migrated may not be compatible with the updated versions and lead to errors in the application code during migration. Further, downtime is generally availed during migration of applications, which may lead to inefficiencies and losses on account of lack of smooth and timely migration activity. Also, migration of applications may pose a threat to integrity and security of data. Furthermore, typically one or more errors in the application code are manually remediated, which may be vulnerable to mistakes. Yet further, existing processes used in application migration are not technology agnostic and scalable and as a result do not meet pertinent requirements. Also, it has been observed that developer productivity during application migration may be impacted by various factors such as, existing codebase complexity, extent of customization and specific requirements of application migration.

In light of the aforementioned drawbacks, there is a need for a system and a method which provides for improved migration of legacy applications. There is a need for a system and a method which provides for seamless migration of application with minimum manual intervention. There is a need for a system and a method which provides for minimizing downtime during application migration. Further, there is a need for a system and a method which provides for maintaining data security and integrity. Also, there is a need for a system and a method which provides for an application migration process which is technology agnostic and adequately meets all pertinent requirements. Yet further, there is a need for system and method for efficient and accurate conversion of legacy application code to target application code (e.g., SAP ECC to SAP S/4HANA).

### SUMMARY

In various embodiments of the present invention, a system for generative artificial intelligence powered migration of legacy applications is provided. The system comprises a memory storing program instructions, a processor executing instructions stored in the memory, and a migration engine executed by the processor. The migration engine is configured to process an input file comprising one or more application code objects associated with a legacy application code by populating data present in the input file in response to triggering of an event. The application code objects are validated to modify the application code objects present in the input file based on an outcome of the validation. The migration engine is configured to integrate the processed input file with a target application to perform a check of the application code objects present in the processed input file iteratively in an automated manner by using one or more recommended variants associated with the target application. Further, the migration engine is configured to extract an outcome of the check as a check file and a non-remediated version of the legacy application code for generating one or more prompts. Lastly, the migration engine is configured to execute the generated prompts iteratively for remediating the non-remediated version of the legacy application code for migration.

In various embodiments of the present invention, a method for generative artificial intelligence powered migration of legacy applications is provided. The method is implemented by a processor executing instructions stored in a memory. The method comprises the steps of processing an input file comprising one or more application code objects associated with a legacy application code by populating data present in the input file in response to triggering of an event. The application code objects are validated to modify the application code objects present in the input file based on an outcome of the validation. The method comprises integrating the processed input file with a target application to perform a check of the application code objects present in the processed input file iteratively in an automated manner by using one or more recommended variants associated with the target application. Further, the method comprises extracting an outcome of the check as a check file and a non-remediated version of the legacy application code for generating one or more prompts. Lastly, the method comprises executing the generated prompts iteratively for remediating the non-remediated version of the legacy application code for migration.

In various embodiments of the present invention, a computer program product is provided. The computer program product comprises a non-transitory computer-readable medium having computer-readable program code stored thereon, the computer-readable program code comprising instructions that, when executed by a processor, cause the processor to process an input file comprising one or more application code objects associated with a legacy application code by populating data present in the input file based on triggering of an event. The application code objects are validated to modify the application code objects present in the input file based on an outcome of the validation. The processed input file is integrated with a target application to perform a check of the application code objects present in the processed input file iteratively in an automated manner by using one or more recommended variants associated with the target application. Further, an outcome of the check is extracted as a check file and a non-remediated version of the legacy application code for generating one or more prompts. Lastly, the generated prompts are executed iteratively for remediating the non-remediated version of the legacy application code for migration.

### BRIEF DESCRIPTION OF THE ACCOMPANYING DRAWINGS

Examples of the present invention are described by way of embodiments illustrated in the accompanying drawings wherein:

FIG. 1 is a detailed block diagram of a system for generative AI powered migration of legacy applications, in accordance with an embodiment of the present invention;

FIG. 2 illustrates a screenshot of a User Interface (UI) depicting an input file associated with a legacy application, in accordance with an embodiment of the present invention;

FIGS. 3 and 4 illustrate a screenshot of the UI depicting a performance check on the input file using one or more recommended variants associated with the target application, in accordance with an embodiment of the present invention;

FIG. 5 illustrates a screenshot of the UI providing a log in screen for logging into an interface associated with a target application, in accordance with an embodiment of the present invention;

FIG. 6 illustrates a screenshot of the UI depicting one or more prompts generated for execution, in accordance with an embodiment of the present invention;

FIG. 7A illustrates a screenshot of the UI depicting application code prior to application migration, and FIG. 7B illustrates a screenshot of the UI depicting application migration for a reconciliation operation, in accordance with an embodiment of the present invention;

FIGS. 8A-8C illustrate a screenshot of the UI depicting application data across different files for the reconciliation operation, in accordance with an embodiment of the present invention;

FIG. 8D illustrates a screenshot of the UI depicting a summary file after the reconciliation operation, in accordance with an embodiment of the present invention;

FIGS. 9A and 9B illustrate a screenshot of the UI depicting a reconciled application code data and a retrofit application code respectively, in accordance with an embodiment of the present invention;

FIGS. 10 and 10A illustrate a flowchart depicting a method for generative AI powered migration of legacy applications, in accordance with an embodiment of the present invention; and

FIG. 11 illustrates an exemplary computer system in which various embodiments of the present invention may be implemented.

### DETAILED DESCRIPTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

Examples of the present invention would now be discussed in context of embodiments as illustrated in the accompanying drawings.

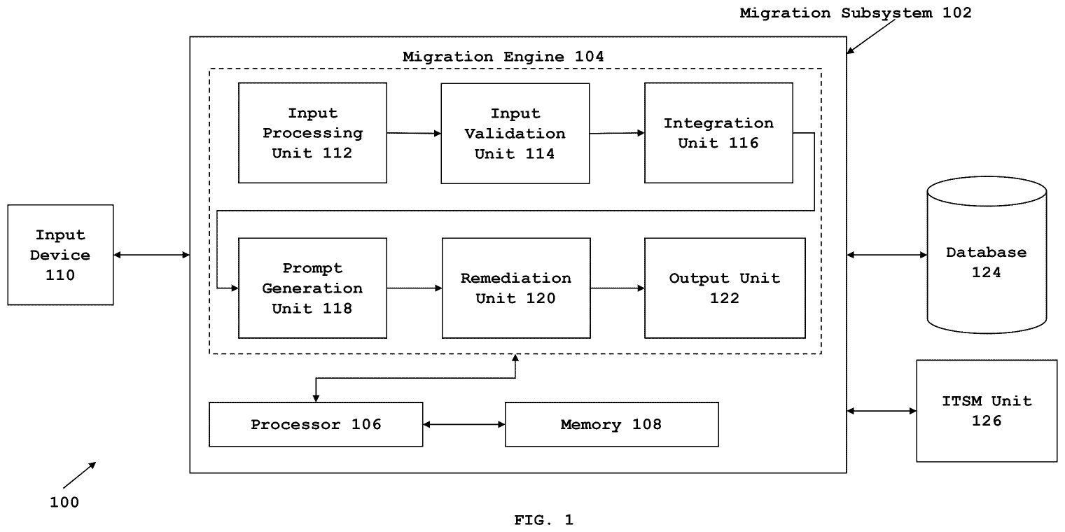

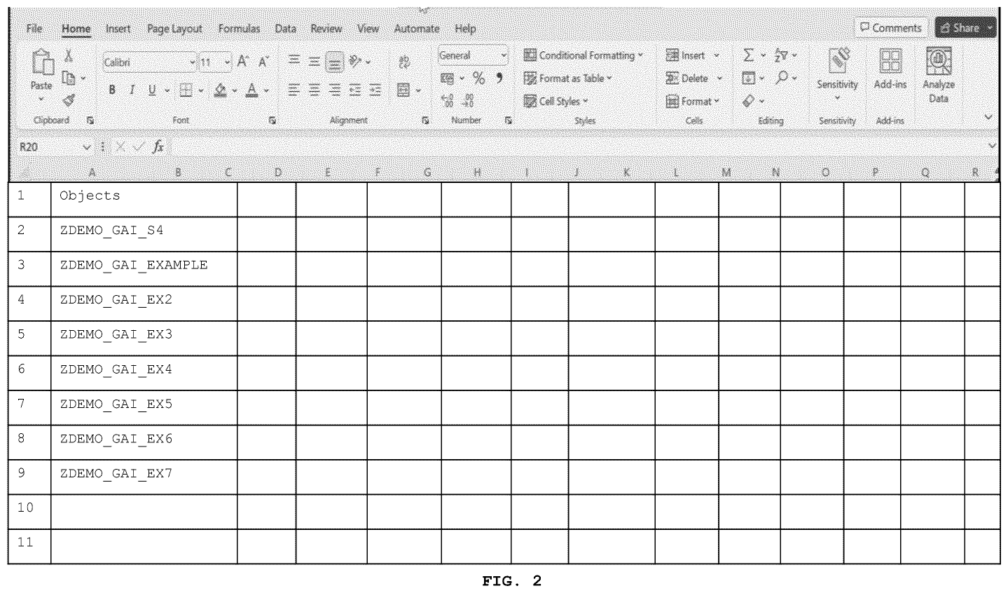

FIG. 1 is a detailed block diagram of a system 100 for generative AI powered migration of legacy applications, in accordance with various embodiments of the present invention. Referring to FIG. 1, in an embodiment of the present invention, the system 100 comprises a migration subsystem 102, an input device 110, a database 124, and an Information Technology Service Management (ITSM) unit 126. In an exemplary embodiment of the present invention, the input device 110, the database 124, and the ITSM unit 126 are connected to the subsystem 102 via a communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a local area network (LAN), a metropolitan area network (MAN) and a wide area network (WAN).

In an embodiment of the present invention, the subsystem 102 is configured to implement Generative Artificial Intelligence (Gen AI) and automation techniques for carrying out detection and remediation of application code errors during application migration. The subsystem 102 is also configured to carry out application code remediation and generation, retrofit automation, intelligent document generation associated with remediated application code, automated data validation and reconciliation.

In an embodiment of the present invention, the subsystem 102 comprises a migration engine 104 (engine 104), a processor 106, and a memory 108. In various embodiments of the present invention, the engine 104 has multiple units which work in conjunction with each other for carrying out automated detection and remediation of application code errors during application migration. The various units of the engine 104 are operated via the processor 106 specifically programmed to execute instructions stored in the memory 108 for executing respective functionalities of the units of the engine 104 in accordance with various embodiments of the present invention.

In another embodiment of the present invention, the subsystem 102 may be implemented in a cloud computing architecture in which data, applications, services, and other resources are stored and delivered through shared datacenters. In an exemplary embodiment of the present invention, the functionalities of the subsystem 102 are delivered to a user as Software as a Service (SaaS) and/or a Platform as a Service (Paas) over a communication network.

In another embodiment of the present invention, the subsystem 102 may be implemented as a client-server architecture. In this embodiment of the present invention, a client terminal accesses a server hosting the subsystem 102 over a communication network. The client terminals may include but are not limited to a smart phone, a computer, a tablet, microcomputer or any other wired or wireless terminal. The server may be a centralized or a decentralized server.

In an embodiment of the present invention, the engine 104 comprises an input processing unit 112, an input validation unit 114, an integration unit 116, a prompt generation unit 120, and an output unit 122.

In operation, in an embodiment of the present invention, the input device 110 is configured to render a user interface (UI) via which input data is received in the form of an input file associated with a legacy application which is required to be migrated. The UI may be built using any one of the programming languages such as, but is not limited to, Python®, JavaScript®, etc. The input device 110 is an electronic device capable of rendering the UI and is associated with an end-user. The electronic device may include a laptop, a computer, a tablet, a smartphone, etc. The end-user may include, but is not limited to, an application developer or a tester, a data scientist, an IT personnel, etc. In an embodiment of the present invention, the input file may be received from the end-user or may be retrieved from a third-party system. The input file comprises one or more application code objects associated with the legacy application which are required to be remediated for migration to a target application, as illustrated in FIG. 2. For example, if the application migration relates to migration of SAP ECC application to a SAP High-performance Analytic Appliance Brownfield Conversion eXpress (S/4HANA BCX) application, then the application code objects which are required to be remediated for migration may include, Advanced Business Application Programming (ABAP) program. The input file may be in a pre-defined format including, but is not limited to, an excel format, Comma Separated Values (CSV) format, text format, etc.

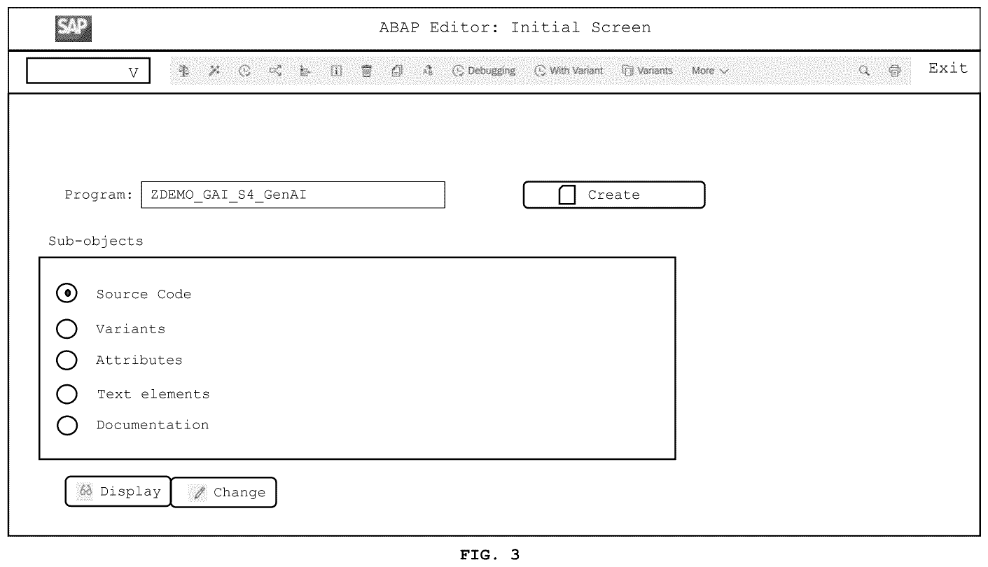

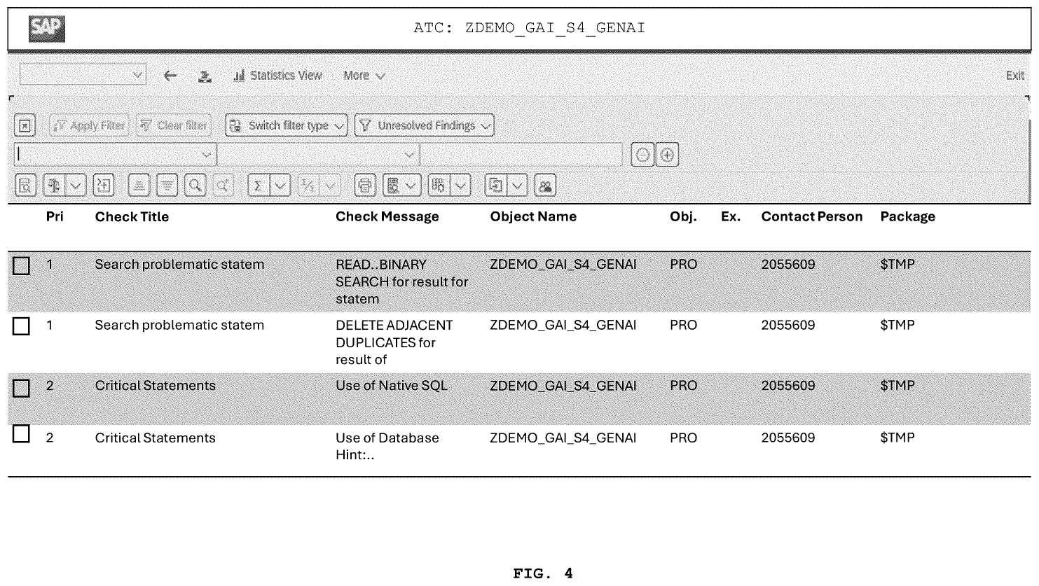

In an embodiment of the present invention, the input file is received by the input processing unit 112 from the input device 110. The input processing unit 112 is configured to process the input file by populating the data present in the input file. The processing of the input file is carried out in response to triggering of an event. In an exemplary embodiment of the present invention, triggering of the event comprises execution of an automation technique for triggering an attended bot providing one or more instructions for processing of the input file or an automated triggering of an unattended bot for processing of the input file. In an embodiment of the present invention, subsequent to triggering of the event, the input validation unit 114 is configured to analyze the application code objects provided in the input file for validating the application code objects and modifying the application code objects present in the input file based on an outcome of the validation. The validation unit 114 performs a check of the application code objects present in the processed input file iteratively in an automated manner by using one or more recommended variants associated with the target application. In an example, an Advanced Business Application Programming (ABAP) Test Cockpit (ATC) validation is performed on the application code objects for the S/4HANA application by using one or more recommended variants. The recommended variants include, but are not limited to, S/4HANA readiness as illustrated in FIGS. 3 and 4. The validation is performed to determine compatibility of the application code objects prior to legacy application migration.

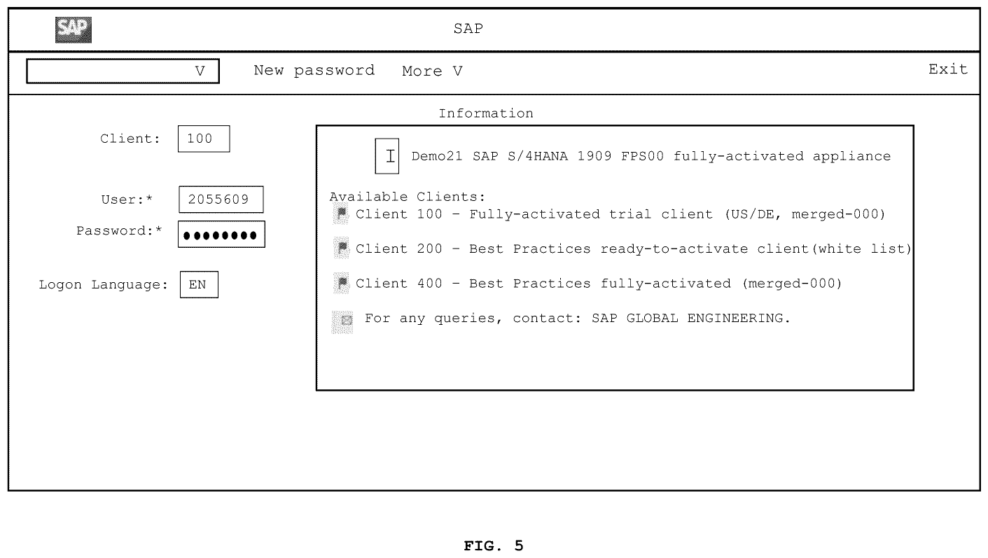

In an embodiment of the present invention, the integration unit 116 is configured to integrate the processed input file with the target application to which the application is required to be migrated. In an exemplary embodiment of the present invention, the integration is carried out by logging into an interface associated with the target application in an automated manner. For example, integration is carried out by logging into an S/4HANA application interface to which the legacy SAP ECC application is required to be migrated, as illustrated in FIG. 5. The integration unit 116 is configured to extract outcome of the validation carried out by the validation unit 114 in a runtime file as a check file and download a non-remediated version of the application code, subsequent to the check. The check file and the non-remediated version of the legacy application code are stored in the database 124 for later retrieval.

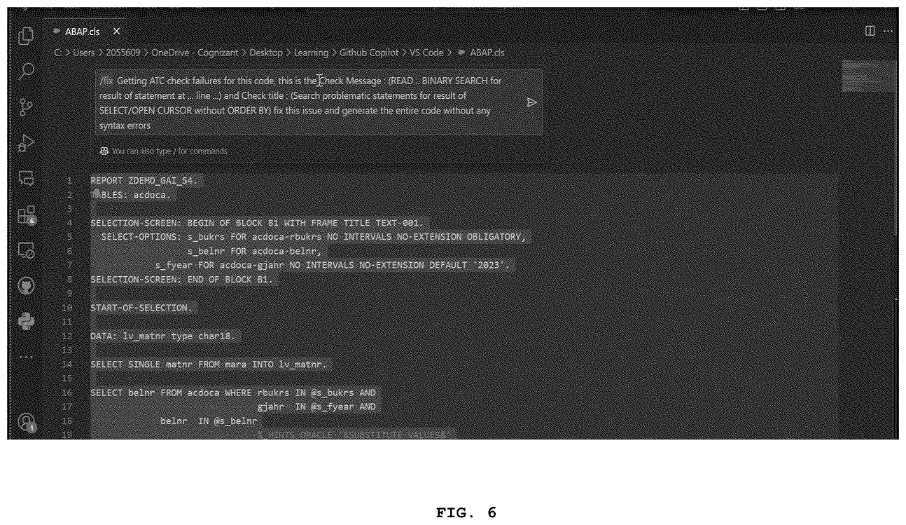

In an embodiment of the present invention, the prompt generation unit 118 is configured to receive the check file and the non-remediated version of the application code. The prompt generation unit 118 is configured to analyze the received check file and the non-remediated version of the application code based on a first set of pre-defined rules for automatically generating one or more prompts for remediating the non-remediated legacy application code, as illustrated in FIG. 6. In an example, the generated prompt for application code remediation may be described as ‘create unit test case for the selected code, cover all positive and negative scenarios’ by employing the first set of pre-defined rules. The prompt generation unit 118 is configured to employ Gen AI techniques, such as, but not limited to, Github Copilot®, Open AIR, Tabnine®, and Gemini® for generating the prompts, which may be located on-premises or in a cloud environment. The prompts are generated based on a second set of pre-defined rules. In an exemplary embodiment of the present invention, the second set of pre-defined rules relate to one or more standard commands associated with the Gen AI techniques such as pre-trained Large Language Models (LLMs) for prompt generation. In an embodiment of the present invention, the generated prompts are stored in the database 124, maintained as prompt libraries, for later retrieval.

In an embodiment of the present invention, the remediation unit 120 is configured to receive the generated prompt, which is executed for remediating the non-remediated version of the legacy application code. The remediation unit 120 is configured to execute the prompt using an application based Gen AI or an Application Programming Interface (API) based Gen AI for remediating the non-remediated version of the legacy application code. The remediation unit 120 is configured to iteratively execute the generated prompt through the non-remediated application code for remediation. In an embodiment of the present invention, a remediated application code is generated by executing the prompt. An exemplary prompt generated for application code remediation may be described as “delete adjacent duplicates for result of statement at specific line number of the application code. Respective check title is also provided as search problematic statements for result of select/open cursor without order. Resolve errors and generate the entire code compatible with target application code without any syntax errors”. In an example, ABAP code remediation is critical during S/4HANA conversion, as S4/HANA is associated with significant architectural and data model changes compared to legacy SAP systems like SAP ECC. ABAP Code remediation involves adapting custom ABAP code to ensure compatibility and optimal performance in S/4HANA. The remediation unit 120 utilizes the remediated application code as input for next iteration for remediating the non-remediated legacy application code. The remediation unit 120 executes the prompt until all the checks in the check file are verified for remediating the non-remediated application code prior to migrating the legacy application code.

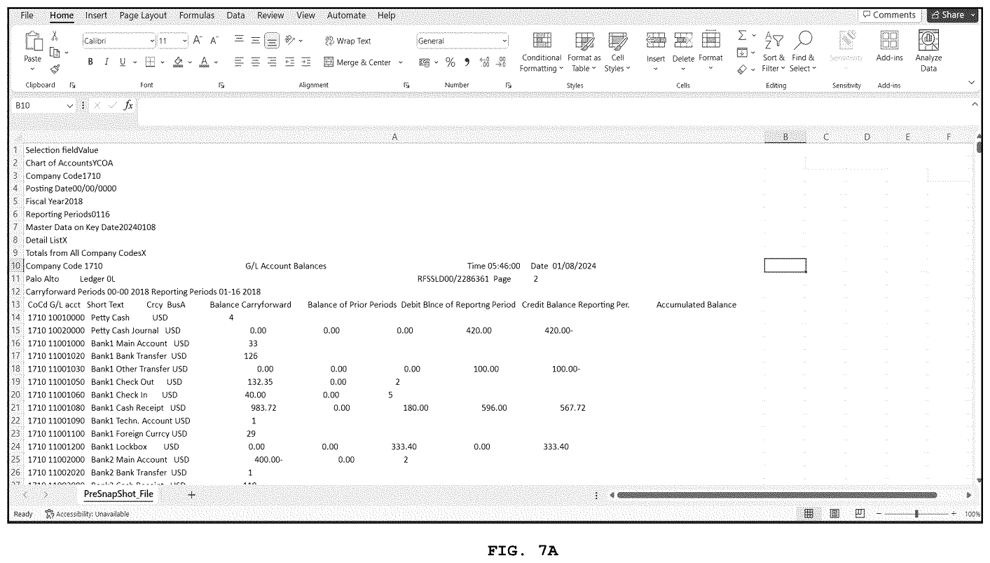

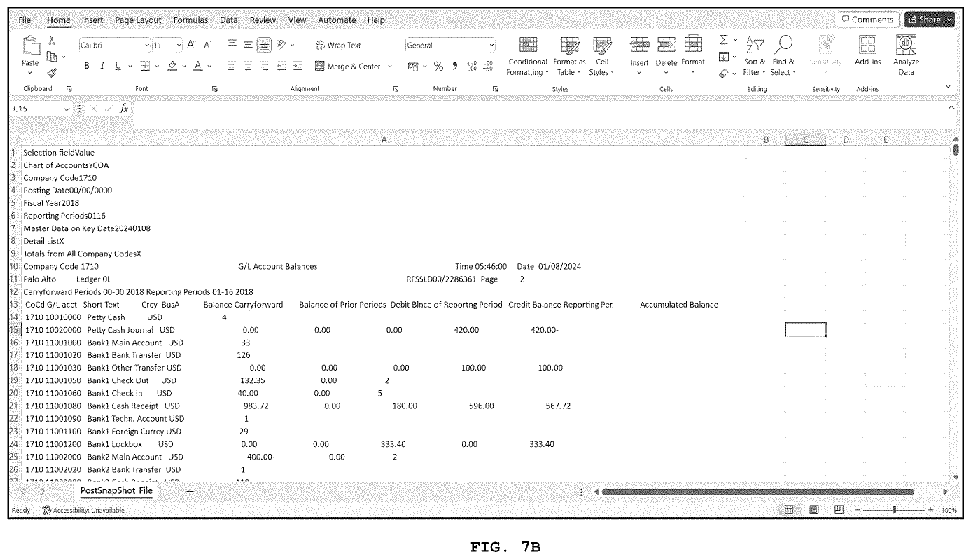

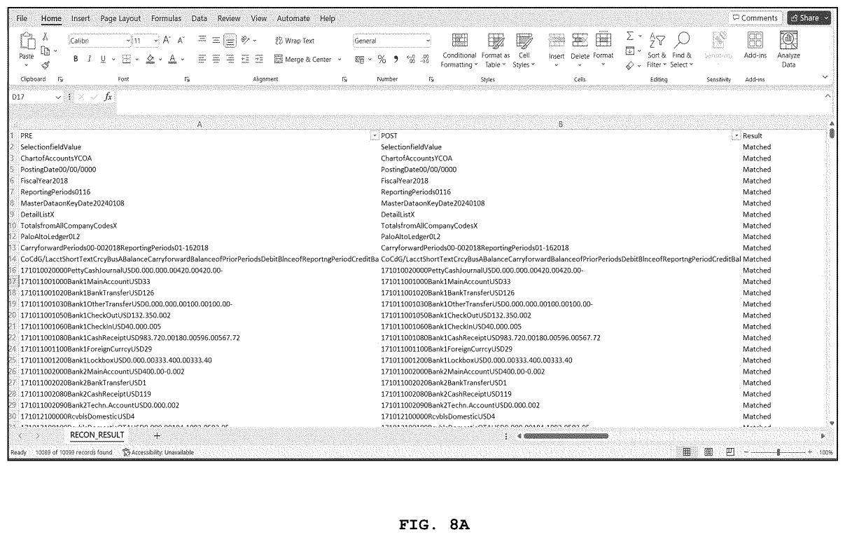

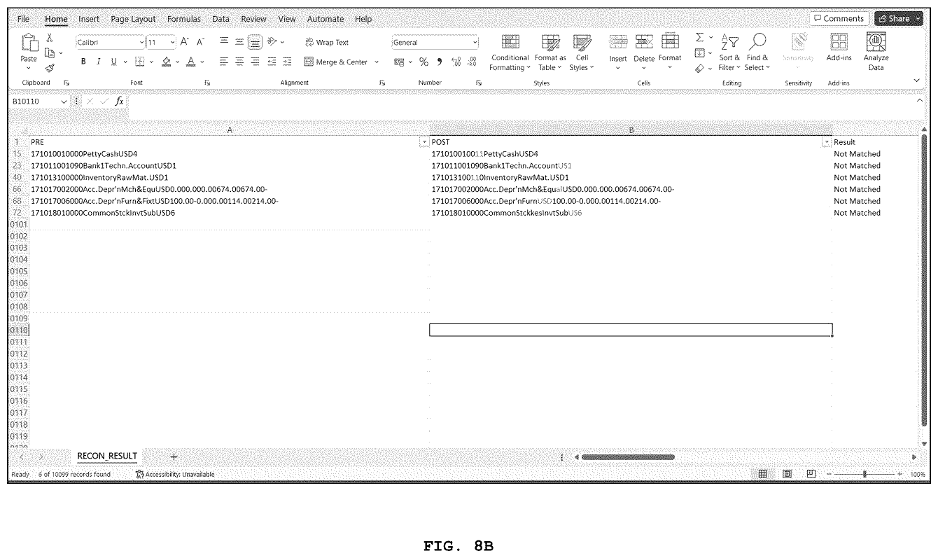

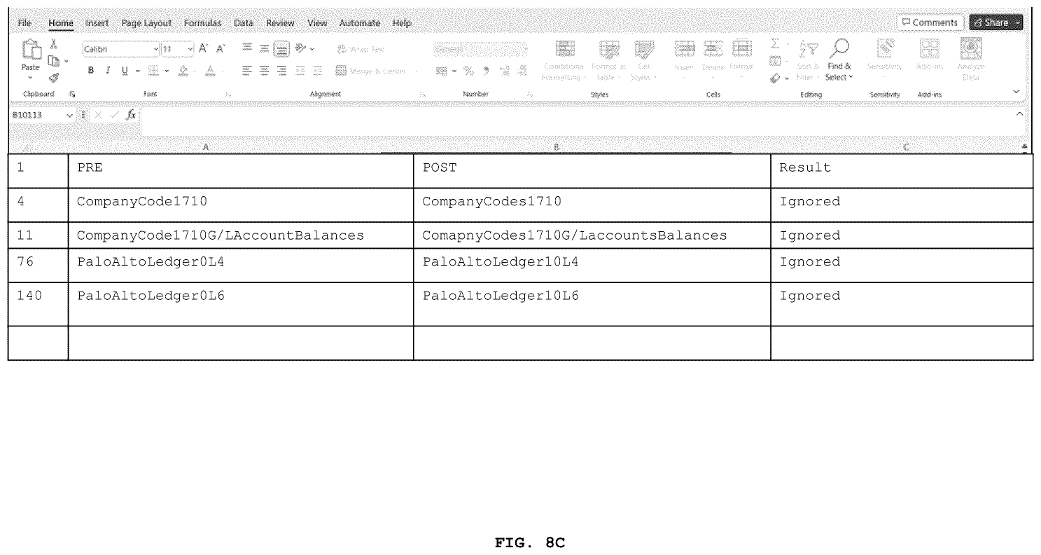

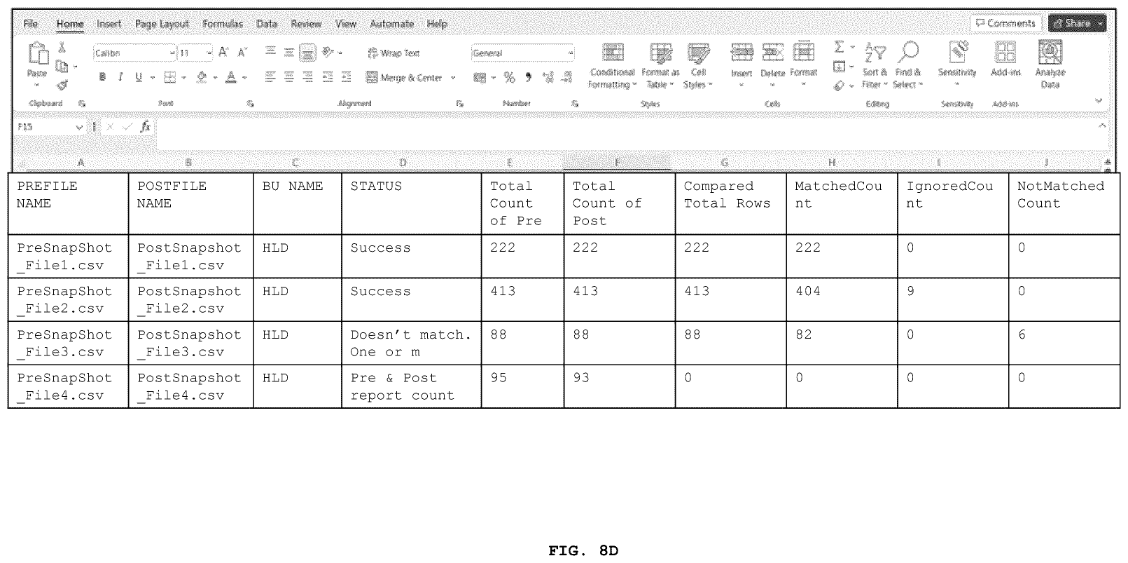

In another embodiment of the present invention, the remediation unit 120 is configured to carry out a retrofit operation on the legacy application code based on the generated prompt for remediating the errors associated with application migration. Retrofit operation synchronizes changes (e.g., customizations, developments, configurations, etc.) made in the legacy application code (e.g., SAP ECC production environment) back to the target application code (e.g., SAP S/4HANA) development landscape. This is critical in parallel landscape scenarios where the legacy application code remains operational during the target application code implementation. In another embodiment of the present invention, the remediation unit 120 is configured to carry out a reconciliation operation for the application migration process by comparing an application code prior to application migration (as illustrated in FIG. 7A) with an application code after application migration (as illustrated in FIG. 7B) in a file form. The remediation unit 120 is configured to compare the two files and generate two new files. The first file is a result file and the second file is a summary file. The result file provides result for the application code lines as matched (FIG. 8A), not matched (FIG. 8B) and ignored (FIG. 8C) for the application prior to migration and after migration for application data across different files for the reconciliation operation. The summary file (FIG. 8D) provides overall result of the reconciliation operation.

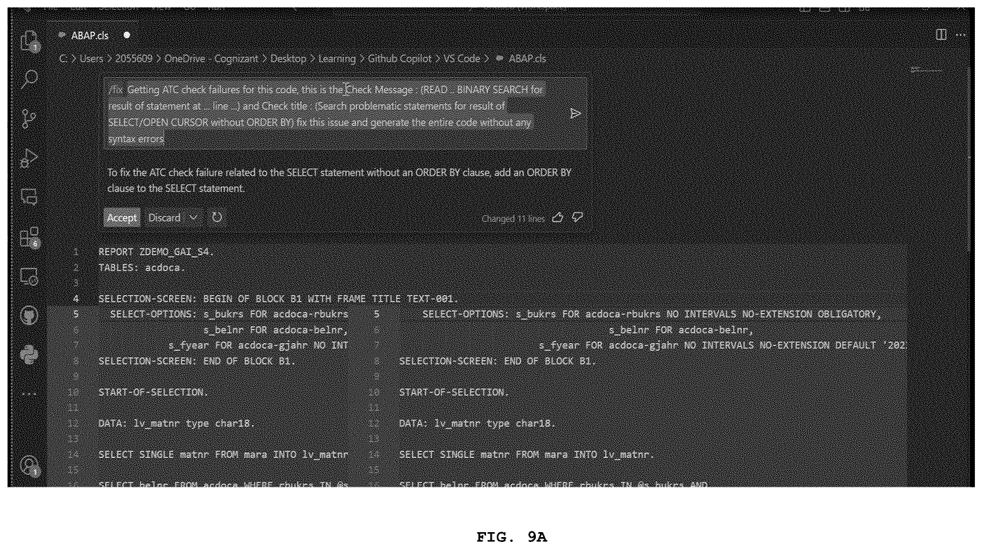

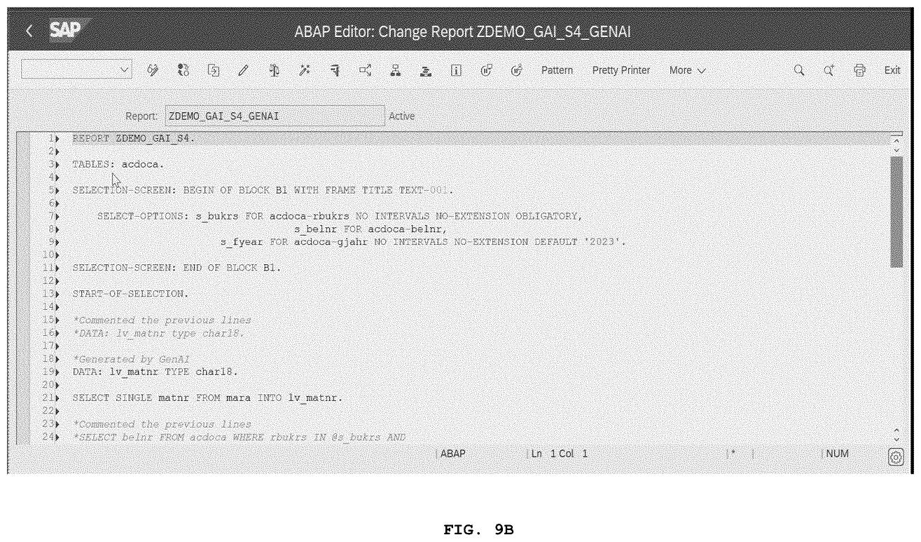

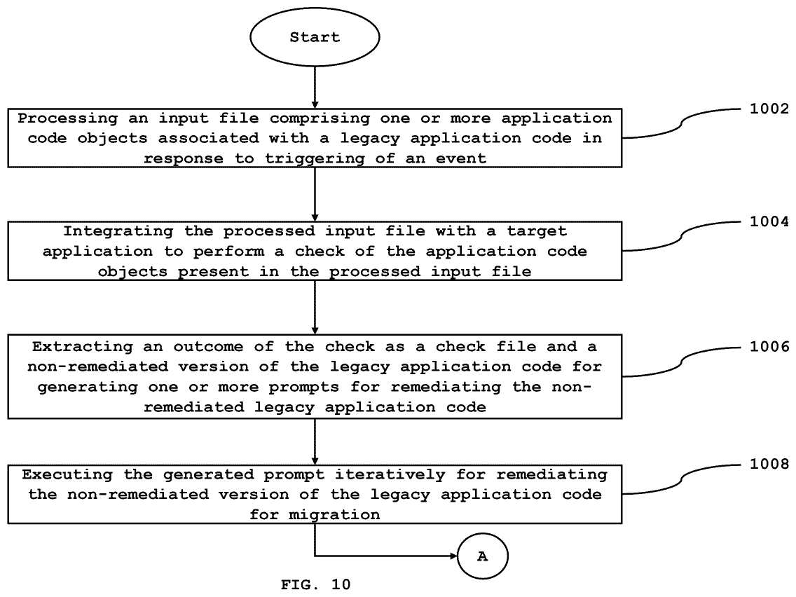

In an embodiment of the present invention, the output unit 122 is configured to receive and process the remediated legacy application code for generating reports and insights providing outcome of the legacy application code remediation and details of the application code object and application quality checks (e.g., ABAP Test Cockpit (ATC) checks) being remediated by the remediation unit 120. Further, the output unit 122, by employing the Gen AI techniques, generates an output file which is used for knowledge transfer and for analyzing the remediated application code for future maintenance and enhancement of the application code. Further, the output unit 122 generates the remediated application code based on one or more application parameters such as, but not limited to, requirement documents, code explanation, test case and validation script generation enabling automated application testing, technical and functional design documentation and determining reverse engineering scenarios. The output unit 122 provides real-time updates in the generated output file by continuously monitoring changes with respect to the application remediation and reflecting modifications in the generated output file. The reports and insights and output file are visualized by the end-user via the UI on the input device 110. The generated report and insights and output file are stored in the database 124 for later retrieval. Further, the output unit 122 is configured to render the reconciled application code data and retrofit application code, as illustrated in FIGS. 9A and 9B respectively. In another embodiment of the present invention, the report and insights and output files may also provide data regarding requirement of manual intervention by the end-user for remediating the errors associated with application code migration. In another embodiment of the present invention, the output unit 122 is configured to send automated notifications (e.g., email notifications) to end-users based on events associated with remediating the errors associated with application code migration. In another embodiment of the present invention, the output unit 122 is configured to capture feedback for continuously improving the generated prompt, which is executed for remediating the errors associated with the application migration.

In an embodiment of the present invention, the migration engine 104 integrates with the ITSM unit 126 for populating the check files (e.g., an ATC check file) based on the application code objects which are yet to be remediated manually and create tickets to assign to individual end-users (e.g., ABAP developers) for carrying out manual remediation of the application code.

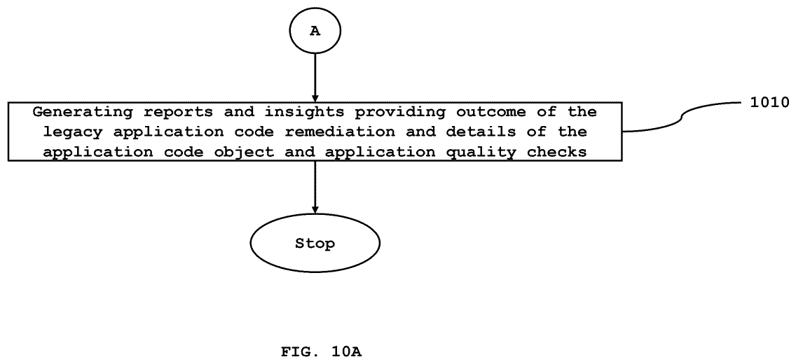

FIGS. 10 and 10A illustrate a flowchart depicting a method for generative AI powered migration of legacy applications, in accordance with an embodiment of the present invention.

At step 1002, an input file comprising one or more application code objects associated with a legacy application code is processed in response to triggering of an event. In an embodiment of the present invention, a UI is rendered via which input data is received in the form of an input file associated with a legacy application which is required to be migrated. The UI may be built using any one of the programming languages including, but is not limited to, Python®, JavaScript®, etc. In an embodiment of the present invention, the input file may be received from an end-user or may be retrieved from a third-party system. The input file comprises one or more application code objects associated with the legacy application which are required to be remediated for migration to a target application. For example, if the application migration relates to migration of SAP ECC application to a SAP High-performance Analytic Appliance Brownfield Conversion eXpress (S/4HANA BCX) application, then the application code objects which are required to be remediated for migration may include, Advanced Business Application Programming (ABAP) program. The input file may be in a pre-defined format including, but is not limited to, an excel format, Comma Separated Values (CSV) format, text format, etc.

In an embodiment of the present invention, the input file is processed by populating the data present in the input file. The processing of the input file is carried out based on triggering of an event. In an exemplary embodiment of the present invention, the triggering of the event comprises execution of an automation technique for triggering an attended bot providing one or more instructions for processing of the input file or an automated triggering of an unattended bot for processing of the input file. In an embodiment of the present invention, subsequent to triggering of the event, the application code objects provided in the input file are analyzed for validating the application code objects and modifying the application code objects present in the input file based on an outcome of the validation. A check of the application code objects present in the processed input file is performed iteratively in an automated manner by using one or more recommended variants associated with the target application. In an example, for the S/4HANA application, ABAP Test Cockpit ATC, validation is performed on the application code objects by using the recommended variants. The recommended variants include, but are not limited to, S/4HANA readiness. The validation is performed to determine compatibility of the application code objects prior to legacy application migration.

At step 1004, the processed input file is integrated with a target application to perform a check of the application code objects present in the processed input file. In an embodiment of the present invention, the processed input file is integrated with the target application to which the application is required to be migrated. In an exemplary embodiment of the present invention, integration is carried out by logging into an interface associated with the target application in an automated manner. For example, integration is carried out by logging into an S/4HANA application interface to which the legacy SAP ECC application is required to be migrated. In an embodiment of the present invention, a check of the application code objects present in the processed input file is performed iteratively in an automated manner by using the one or more recommended variants associated with the target application. In an embodiment of the present invention, outcome of the check is extracted in a runtime file as a check file and download a non-remediated version of the application code, subsequent to the check.

At step 1006, an outcome of the check is extracted as a check file and a non-remediated version of the legacy application code for generating one or more prompts for remediating the non-remediated legacy application code. In an embodiment of the present invention, the check file and the non-remediated version of the application code are analyzed based on a first set of pre-defined rules for automatically generating one or more prompts for remediating the non-remediated legacy application code. In an example, the generated prompt for application code remediation may be described as ‘create unit test case for the selected code, cover all positive and negative scenarios’ by employing the first set of pre-defined rules. Gen AI techniques, including, but not limited to, Github Copilot®, Open AIR, Tabnine®, and Gemini® are employed for generating the prompts, which may be located on-premises or in a cloud environment. The prompts are generated based on a second set of pre-defined rules. In an exemplary embodiment of the present invention, the second set of pre-defined rules relate to one or more standard commands associated with the Gen AI techniques such as pre-trained LLMS for prompt generation.

At step 1008, the generated prompt is executed iteratively for remediating the non-remediated version of the legacy application code for migration. In an embodiment of the present invention, the generated prompt is executed for remediating the non-remediated version of the legacy application code. The prompt is executed using an application based Gen AI or an API based Gen AI for remediating the non-remediated version of the legacy application code. The generated prompt is iteratively executed through the non-remediated application code for remediation. In an embodiment of the present invention, a remediated application code is generated by executing the prompt. In an example, ABAP code remediation is critical during S/4HANA conversion as S4/HANA is associated with significant architectural and data model changes compared to legacy SAP systems like SAP ECC. ABAP Code remediation involves adapting custom ABAP code to ensure compatibility and optimal performance in S/4HANA. The remediated application code is utilized as input for next iteration for remediating the non-remediated legacy application code. The prompt is executed until all the checks in the check file are verified for remediating the non-remediated application code prior to migrating the legacy application code.

In another embodiment of the present invention, a retrofit operation is carried out on the legacy application code based on the generated prompt for remediating the errors associated with application migration. Retrofit operation synchronizes changes (e.g., customizations, developments, configurations, etc.) made in the legacy application code (e.g., SAP ECC production environment) back to the target application code (e.g., SAP S/4HANA) development landscape. This is critical in parallel landscape scenarios where the legacy application code remains operational during the target application code implementation. In yet another embodiment of the present invention, a reconciliation operation is carried out for the application migration process by comparing an application code prior to application migration with an application code after application migration in a file form. The two files are compared, and two new files are generated. The first file is a result file, and the second file is a summary file. The result file provides result for the application code lines as matched, not matched, and ignored for the application prior to migration and after migration for application data across different files for the reconciliation operation. The summary file provides overall result of the reconciliation operation.

At step 1010, reports and insights are generated providing outcome of the legacy application code remediation and details of the application code object and application quality checks. In an embodiment of the present invention, the remediated legacy application code is processed for generating reports and insights providing outcome of the legacy application code remediation and details of the application code object and application quality checks (e.g., ABAP Test Cockpit (ATC) checks) being remediated. Further, the Gen AI techniques are employed for generating an output file which is used for knowledge transfer and for analyzing the remediated application code for future maintenance and enhancement of the application code. The remediated application code is generated based on one or more application parameters such as, but not limited to, requirement documents, code explanation, test case and validation script generation enabling automated application testing, technical and functional design documentation and determining reverse engineering scenarios. Real-time updates are provided in the generated output file by continuously monitoring changes with respect to the application remediation and reflecting modifications in the generated output file. The reports and insights and output file are visualized by the end-user via the UI. In another embodiment of the present invention, the report and insights and output files may also provide data regarding the requirement of manual intervention by the end-user for remediating the errors associated with application code migration. In another embodiment of the present invention, automated notifications (e.g., email notifications) are sent to end-users based on events associated with remediating the errors associated with application code migration. In another embodiment of the present invention, feedback is captured for continuously improving the generated prompt, which is executed for remediating the errors associated with the application migration.

Advantageously, in accordance with various embodiments of the present invention, the present invention provides for automated detection and remediation of application code errors for application migration based on automation and Gen AI techniques. Examples of the present invention provide for efficient, and seamless migration of legacy application to upgraded applications catering to data volume, technology landscape, cost, and implementation timeline. Examples of the present invention provide for automated upgrade and development lifecycle for an application hosting a variety of reusable automation components associated with activities involved in the migration process. Further, examples of the present invention provide for improving developer productivity from 50% to 60%, boosting engineering velocity, application code quality and accelerating migration process. Furthermore, examples of the present invention provide for reduced validation and data reconciliation timeline by 40% to 50%, downtime reduction by 25% and effort reduction by 60%. Also, examples of the present invention provide for maintaining data, robustness, security, and integrity. Yet further, examples of the present invention provide for integrating and managing pre-defined rules for remediation of errors during application code migration. Furthermore, examples of the present invention provide for workflow orchestration associated with remediation of errors during application code migration. Yet further, examples of the present invention provide for automated task generation and assignment for remediation of errors during application code migration. Further, examples of the present invention provide for automated test case generation for testing of the rectified application code for application migration. Furthermore, examples of the present invention provide for leveraging Gen AI and automation techniques for remediating custom code extraction and further automatically remediate custom application code based on best practices using Gen AI driven optimization suggestions. Yet further, examples of the present invention provide application migration process which is technology agnostic, scalable and sufficiently meet user needs and requirements.

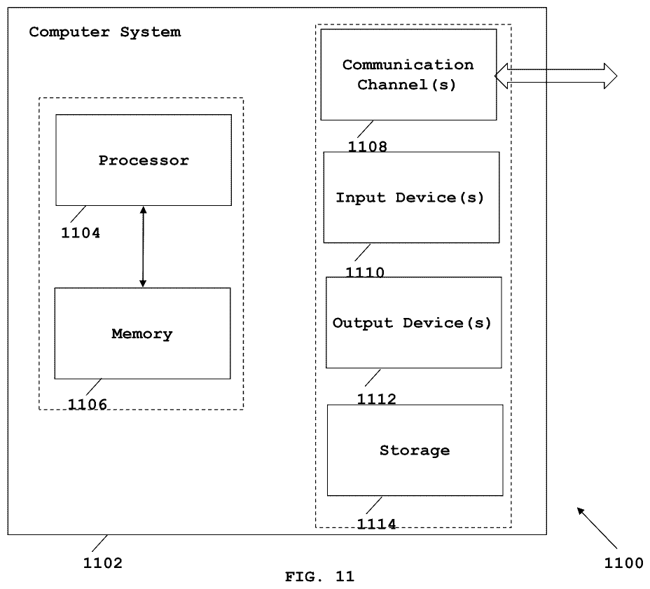

FIG. 11 illustrates an exemplary computer system in which various embodiments of the present invention may be implemented. The computer system 1102 comprises a processor 1004 and a memory 1106. The processor 1104 executes program instructions and is a real processor. The computer system 1102 is not intended to suggest any limitation as to scope of use or functionality of described embodiments. For example, the computer system 1102 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 1106 may store software for implementing various embodiments of the present invention. The computer system 1102 may have additional components. For example, the computer system 1102 includes one or more communication channels 1108, one or more input devices 1110, one or more output devices 1112, and storage 1114. An interconnection mechanism (not shown) such as a bus, controller, or network, interconnects the components of the computer system 1102. In various embodiments of the present invention, operating system software (not shown) provides an operating environment for various softwares executing in the computer system 1102 and manages different functionalities of the components of the computer system 1102.

The communication channel(s) 1108 allows communication over a communication medium to various other computing entities. The communication medium provides information such as program instructions, or other data in a communication media. The communication media includes, but are not limited to, wired or wireless methodologies implemented with an electrical, optical, RF, infrared, acoustic, microwave, Bluetooth, or other transmission media.

The input device(s) 1110 may include, but not limited to, a keyboard, mouse, pen, joystick, trackball, a voice device, a scanning device, touch screen or any another device that is capable of providing input to the computer system 1102. In an embodiment of the present invention, the input device(s) 1110 may be a sound card or similar device that accepts audio input in analog or digital form. The output device(s) 1112 may include, but not limited to, a user interface on CRT or LCD, printer, speaker, CD/DVD writer, or any other device that provides output from the computer system 1102.

The storage 1114 may include, but not limited to, magnetic disks, magnetic tapes, CD-ROMs, CD-RWs, DVDs, flash drives or any other medium which can be used to store information and can be accessed by the computer system 1102. In various embodiments of the present invention, the storage 1114 contains program instructions for implementing the described embodiments.

Examples of the present invention may suitably be embodied as a computer program product for use with the computer system 1102. The method described herein is typically implemented as a computer program product, comprising a set of program instructions which is executed by the computer system 1102 or any other similar device. The set of program instructions may be a series of computer readable codes stored on a tangible medium, such as a computer readable storage medium (storage 1114), for example, diskette, CD-ROM, ROM, flash drives or hard disk, or transmittable to the computer system 1102, via a modem or other interface device, over either a tangible medium, including but not limited to optical or analogue communications channel(s) 1108. The implementation of the invention as a computer program product may be in an intangible form using wireless techniques, including but not limited to microwave, infrared, Bluetooth, or other transmission techniques. These instructions can be preloaded into a system or recorded on a storage medium such as a CD-ROM or made available for downloading over a network such as the internet or a mobile telephone network. The series of computer readable instructions may embody all or part of the functionality previously described herein.

Examples of the present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for Generative AI (Gen AI) powered migration of legacy applications, the system comprises:
a memory storing program instructions;
a processor executing instructions stored in the memory; and
a migration engine executed by the processor and configured to:
process an input file comprising one or more application code objects associated with a legacy application code by populating data present in the input file in response to triggering of an event, wherein the application code objects are validated to modify the application code objects present in the input file based on an outcome of the validation;
integrate the processed input file with a target application to perform a check of the application code objects present in the processed input file iteratively in an automated manner by using one or more recommended variants associated with the target application;
extract an outcome of the check as a check file and a non-remediated version of the legacy application code for generating one or more prompts; and
execute the generated prompts iteratively for remediating the non-remediated version of the legacy application code for migration.

2. The system as claimed in claim 1, wherein the input file comprises the one or more application code objects associated with a legacy application which are required to be remediated for migration to a target application.

3. The system as claimed in claim 1, wherein the application code objects are validated in the legacy application by checking the application code objects present in the processed input file iteratively in an automated manner by using the one or more recommended variants associated with the target application to determine compatibility of the application code objects prior to legacy application migration, and the triggering of the event comprises execution of an automation technique for triggering an attended bot providing one or more instructions for processing of the input file or an automated triggering of an unattended bot for processing of the input file.

4. The system as claimed in claim 1, wherein the migration engine comprises an input validation unit executed by the processor and configured to analyze the application code objects provided in the input file for validating the application code objects based on the first set of pre-defined rules.

5. The system as claimed in claim 1, wherein the migration engine comprises a prompt generation unit executed by the processor and configured to analyze the received check file and the non-remediated version of the application code based on a first set of pre-defined rules for automatically generating the one or more prompts for remediating the non-remediated legacy application code based on a second set of pre-defined rules.

6. The system as claimed in claim 1, wherein the migration engine comprises a remediation unit executed by the processor and configured to execute the prompt using an application based Gen AI or an Application Programming Interface (API) based Gen AI for remediating the non-remediated version of the legacy application code.

7. The system as claimed in claim 6, wherein the remediation unit utilizes the remediated application code as input for the next iteration for remediating the non-remediated legacy application code, and wherein the remediation unit executes the prompt until all the checks in the check file are verified for remediating the non-remediated application code prior to migrating the legacy application code.

8. The system as claimed in claim 6, wherein the remediation unit is configured to carry out a retrofit operation on the legacy application code based on the generated prompt for remediating the errors associated with application migration, and wherein the remediation unit is configured to carry out a reconciliation operation for the application migration process by comparing an application code prior to application migration with an application code after application migration in a file form.

9. The system as claimed in claim 1, wherein the migration engine comprises an output unit executed by the processor and configured to receive the remediated legacy application code for generating reports and insights providing outcome of the legacy application code remediation and details on the application code object and application quality checks.

10. The system as claimed in claim 9, wherein the output unit, by employing the Gen AI techniques, generates an output file which is used for knowledge transfer and for analyzing the remediated application code for future maintenance and enhancement of the application code, and wherein the output unit generates the remediated application code based on one or more application parameters comprising requirement documents, code explanation, test case and validation script generation enabling automated application testing, technical and functional design documentation and determining reverse engineering scenarios.

11. The system as claimed in claim 10, wherein the output unit provides real-time updates in the generated output file by continuously monitoring changes with respect to the application remediation and reflecting the modifications in generated output file, and wherein the output unit is configured to capture a feedback for continuously improving the prompt generation which is executed for remediating errors associated with the application migration.

12. A method for Generative AI (Gen AI) powered migration of legacy applications, the method is implemented by a processor executing instructions stored in a memory, the method comprises the steps of:
processing an input file comprising one or more application code objects associated with a legacy application code by populating data present in the input file in response to triggering of an event, wherein the application code objects are validated to modify the application code objects present in the input file based on an outcome of the validation;
integrating the processed input file with a target application to perform a check of the application code objects present in the processed input file iteratively in an automated manner by using one or more recommended variants associated with the target application;
extracting an outcome of the check as a check file and a non-remediated version of the legacy application code for generating one or more prompts; and
executing the generated prompts iteratively for remediating the non-remediated version of the legacy application code for migration.

13. The method as claimed in claim 12, wherein the method comprises validating the application code objects in the legacy application by checking the application code objects present in the processed input file iteratively in an automated manner by using the one or more recommended variants associated with the target application to determine compatibility of the application code objects prior to legacy application migration, and the triggering of the event comprises execution of an automation technique for triggering an attended bot providing one or more instructions for processing of the input file or an automated triggering of an unattended bot for processing of the input file.

14. The method as claimed in claim 12, wherein the received check file and the non-remediated version of the application code are analyzed based on a first set of pre-defined rules for automatically generating the one or more prompts for remediating the non-remediated legacy application code based on a second set of pre-defined rules.

15. The method as claimed in claim 12, wherein the remediated application code is utilized as input for the next iteration for remediating the non-remediated legacy application code, and wherein the prompt is executed until all the checks in the check file are verified for remediating the non-remediated application code prior to migrating the legacy application code.

16. The method as claimed in claim 15, wherein a retrofit operation is carried out on the legacy application code based on the generated prompt for remediating the errors associated with application migration, and wherein a reconciliation operation is carried out for the application migration process by comparing an application code prior to application migration with an application code after application migration in a file form.

17. The method as claimed in claim 12, wherein the remediated legacy application code is used for generating reports and insights providing outcome of the legacy application code remediation and details on the application code object and application quality checks.

18. The method as claimed in claim 17, wherein an output file is generated which is used for knowledge transfer and for analyzing the remediated application code for future maintenance and enhancement of the application code, and wherein the remediated application code is generated based on one or more application parameters comprising requirement documents, code explanation, test case and validation script generation enabling automated application testing, technical and functional design documentation and determining reverse engineering scenarios.

19. The method as claimed in claim 18, wherein real-time updates are provided in the generated output file by continuously monitoring changes with respect to the application remediation and reflecting the modifications in generated output file, and wherein a feedback is captured for continuously improving the prompt generation which is executed for remediating errors associated with the application migration.

20. A non-transitory computer program product comprising:
a non-transitory computer-readable medium having computer-readable program code stored thereon, the computer-readable program code comprising instructions that, when executed by a processor, cause the processor to:
process an input file comprising one or more application code objects associated with a legacy application code by populating data present in the input file based on triggering of an event, wherein the application code objects are validated to modify the application code objects present in the input file based on an outcome of the validation;
integrate the processed input file with a target application to perform a check of the application code objects present in the processed input file iteratively in an automated manner by using one or more recommended variants associated with the target application;
extract an outcome of the check as a check file and a non-remediated version of the legacy application code for generating one or more prompts; and
execute the generated prompts iteratively for remediating the non-remediated version of the legacy application code for migration.
